(19) United States
(12) Patent Application Publication
(10) Pub. No.: US 2026/0332692 A1
(43) Pub. Date: Oct. 22, 2026

(54) FLEXIBLE DEFORMATION HOLDER

(71) Applicant: Lihong Zhang, Shenzhen (CN)

(72) Inventors: Yixi Liang, Guigang (CN); Lihong Zhang, Shenzhen (CN)

(21) Appl. No.: 19/713,061

(22) Filed: Jun. 18, 2026

(30) Foreign Application Priority Data
Jul. 15, 2025 (CN) 202521482859.0

(51) Int. Cl. H04M 1/04; F16M 13/02

(52) U.S. Cl. CPC H04M 1/04; F16M 13/022

(57) ABSTRACT

Provided is a flexible deformation holder, which includes a foldable plate body, and a plurality of first foldable portion are arranged in parallel spacing on one side of the foldable plate body. The first foldable portions are used for bending deformation of the foldable plate body and can be maintained after bending deformation, so as to bend the foldable plate body into the holder. In this way, through the structural design of the foldable plate body, it can be transformed into various placement states during bending, which can meet the user's different angle usage requirements. Secondly, the bending and opening operation mode of the foldable plate body is simple. When in use, the material characteristics of the foldable plate body are used for bending the foldable plate body is bent into the holder, which can be stored in sheet form or folded up when not in use.

### CROSS-REFERENCE TO RELATED APPLICATIONS

This application claims priority to Chinese Patent Application No. 202521482859.0, filed on Jul. 15, 2025, which is hereby incorporated by reference in its entirety.

### TECHNICAL FIELD

The present disclosure relates to the field of electronic device accessories technologies, and in particular, to a flexible deformation holder.

### BACKGROUND

Currently, smartphones are widely used, and watching videos and articles through mobile phones has become a common way for people to read. Usually, people are accustomed to watching videos in landscape and articles in portrait orientation, and the reading time is relatively long. If they directly use their hands as support, it will not only be inconvenient, but also burden the eyes and shoulders, which is not conducive to health in the long run. Therefore, the application of mobile phone holders has emerged.

There is a folding phone holder in the existing technology, which includes an installation base and a folding holder; the installation base includes an installation groove, an elastic support plate, and an adhesive plate. A first sliding groove is provided in the installation groove, and the elastic support plate is provided in the first sliding groove. The adhesive plate is clamped with the bottom surface of the installation groove, or the adhesive plate is slidably provided in the first sliding groove. The adhesive plate is located below the elastic support plate, and a glue layer for sticking to the back of the mobile phone is provided below the adhesive plate; the folding holder includes a rotating base, and a sliding plate is provided at the bottom of the rotating base. The sliding plate is provided in the first sliding groove and is located on the elastic support plate. The folding phone holder can achieve vertical placement of the phone or horizontal placement of the phone by changing the style to switch the support angle. However, this type of folding phone holder has the following defects: for example, it requires many components to achieve the support function of the phone holder, which makes it difficult to assemble. Secondly, this type of folding phone holder can only achieve support angles in both horizontal and vertical directions, and there is still a problem of limited support angles. Finally, when not in use, this type of folding phone holder occupies a large space and is inconvenient to carry and store.

Therefore, it is necessary to study a new technological solution to solve the above problems.

### SUMMARY

In view of this, the main purpose of the present disclosure is to provide a flexible deformation holder that addresses the shortcomings of existing technology. In fact, through the structural design of a foldable plate body, it can be transformed into various placement states during bending, which can meet the usage requirements of a user from different angles.

Secondly, the bending, unfolding, and closing operation of the foldable plate body is simple. When in use, the foldable plate body is bent using its own material characteristics to form a holder. When not in use, it can be folded into a sheet or folded for storage, taking up less space and making it convenient to carry and store.

A flexible deformation holder, including: a foldable plate body, where a plurality of first foldable portions arranged in parallel spacing are provided on one side of the foldable plate body, the first foldable portions are configured for bending deformation of the foldable plate body and are configured to be maintained after bending deformation so as to bend the foldable plate body into the holder.

In some embodiments of the present disclosure, there are at least two first foldable portions, which are defined as a first bending portion and a second bending portion, respectively; correspondingly, the foldable plate body is divided into a first support body, a second support body, and a third support body; the first bending portion is provided at a junction of the first support body and the second support body, and the second bending portion is provided at a junction of the second support body and the third support body;
when in a bent use state, the second support body is configured to bent upwards relative to a front end of the first support body through the first bending portion, thereby forming an electronic device placement area between the first and second support bodies; the third support body is configured to bent downwards relative to a rear end of the second support body through the second bending portion.

In some embodiments of the present disclosure, there are at least three first foldable portions, which are respectively defined as a bending portion, a second bending portion, and a third bending portion; correspondingly, the foldable plate body is divided into a first support body, a second support body, a third support body, and a fourth support body; the first bending portion is provided at a junction of the first support body and the second support body, the second bending portion is provided at a junction of the second support body and the third support body, and the third bending portion is provided at a junction between the third support body and the fourth support body,
when in a bent use state, the first support body is configured to bent upward relative to a front end of the second support body through the first bending portion, thereby forming an electronic device placement area between the first and second support bodies; the third support body is configured to be bent downward relative to a rear end of the second support body through the second bending portion; the fourth support body is configured to be bent forward relative to a lower end of the third support body through the third bending portion, thereby forming a triangular support structure between the second, third, and fourth support bodies.

In some embodiments of the present disclosure, the foldable plate body has a front and back surface that are relatively arranged, and the front and back surfaces are respectively provided with a first suction member and a second suction member configured to adsorb adsorbable objects, and the first suction member and the second suction member are arranged staggered.

In some embodiments of the present disclosure, there are at least five first foldable portions, which are defined as a first bending portion, a second bending portion, a third bending portion, a fourth bending portion, and a fifth bending portion, respectively; correspondingly, the foldable plate body is divided into a first support body, a second support body, a third support body, a fourth support body, a fifth support body, and a sixth support body;
the first bending portion is provided at a junction of the first support body and the second support body, the second bending portion is provided at a junction of the second support body and the third support body, the third bending portion is provided at a junction of the third support body and the fourth support body, the fourth bending portion is provided at a junction of the fourth support body and the fifth support body, and the fifth bending portion is provided at a junction of the fifth support body and the sixth support body;
when in a bent use state, the first support body is configured to be bent downwards relative to a front end of the second support body through the first bending portion;
the third support body is configured to be bent downwards relative to a rear end of the second support body through the second bending portion, so that a hanging position configured to hang on a display screen or an object is formed between the first support body, the second support body, and the third support body; the fourth support body is configured to be bent forward relative to a lower end of the third bending portion through the third bending portion; the fifth support body is configured to be bent downwards relative to a front end of the fourth bending portion through the fourth bending portion; the sixth support body is configured to be bent upwards relative to a rear end of the fifth support body through the fifth bending portion, so that an electronic device placement area is formed between the third support body, the fifth support body, and the sixth support body.

In some embodiments of the present disclosure, the foldable plate body is further provided with a first inclined crease and a second inclined crease, and the first inclined crease and the second inclined crease extend obliquely relative to the first foldable portions, and two ends of the first inclined crease and the second inclined crease respectively extend to adjacent two sides of the foldable plate body.

In some embodiments of the present disclosure, there are at least two first foldable portions, which are respectively defined as a first bending portion and a second bending portion, and the foldable plate body is divided into a first support body, a second support body, a third support body, a fourth support body, and a fifth support body;
when in a bent use state, the second support body is configured to be bent downwards relative to a front end of the second support body through the first bending portion, the third support body is configured to be bent backwards relative to a lower end of the second support body through the second bending portion, the fourth support body is configured to be bent upwards relative to a left end of the third support body through the first inclined crease, and the fifth support body is configured to be bent upwards relative to a right end of the third support body through the second inclined crease, so that upper ends of the fourth and fifth support bodies respectively abut against the first support body, and a holder structure is formed between the first support body, the second support body, the third support body, the fourth support body, and the fifth support body, where the first support body is configured to place an electronic device.

In some embodiments of the present disclosure, the foldable plate body is made of aluminum, copper, or iron material.

Compared with the existing technology, the present disclosure has obvious advantages and beneficial effects. Specifically, as can be seen from the above technical solution, it mainly adopts the structural design of the foldable plate body, which can be transformed into various placement states during bending, and can meet the different angle requirements of the user;
secondly, the bending, unfolding, and closing operation of the foldable plate body is simple; when in use, the foldable plate body is bent using its own material characteristics to form the holder; when not in use, it can be folded into a sheet or folded for storage, taking up less space and rendering it convenient to carry and store; and through the design of the plurality of first foldable portions, the foldable plate body can be bent and deformed, and can be maintained after bending deformation; then, the cooperation between the plurality of first foldable portions and the foldable plate body can be easily transformed into various placement states; at the same time, the first foldable portions can provide bending guidance to facilitate bending along the first foldable portions.

To clarify the structural features and efficacy of the present disclosure, the following will provide a detailed explanation of the present disclosure in combination with the accompanying drawings and specific embodiments.

### BRIEF DESCRIPTION OF DRAWINGS

FIG. 1 is a three-dimensional diagram in an embodiment of the present disclosure.

FIG. 2 is a cross-sectional view diagram in an embodiment of the present disclosure.

FIG. 3 is another three-dimensional diagram in an embodiment of the present disclosure.

FIG. 4 is an enlarged partial view of part A in FIG. 2.

FIG. 5 is a first usage state schematic diagram in an embodiment of the present disclosure.

FIG. 6 is a second usage state schematic diagram in an embodiment of the present disclosure.

FIG. 7 is a third usage state schematic diagram in an embodiment of the present disclosure.

FIG. 8 is a fourth usage state schematic diagram in an embodiment of the present disclosure.

FIG. 9 is a fifth usage state schematic diagram in an embodiment of the present disclosure.

FIG. 10 is a storage state diagram (a foldable plate body is in a semi-rolled shape) in an embodiment of the present disclosure.

FIG. 11 is a storage state diagram (the foldable plate body is in a fully rolled shape) in an embodiment of the present disclosure.

Numeral reference: 10A—foldable plate body, 101A—first support body, 102A—second support body, 103A—third support body, 104A—fourth support body, 105A—fifth support body, 106A—sixth support body, 131—first suction cup 132—second suction cup, 15—first foldable portion, 151—first bending portion, 152—second bending portion, 153—third bending portion, 154—fourth bending portion, 155—fifth bending portion, 16—electronic device placement area, 17—hanging position, 18—first inclined crease, 19—second inclined crease.

### DESCRIPTION OF EMBODIMENTS

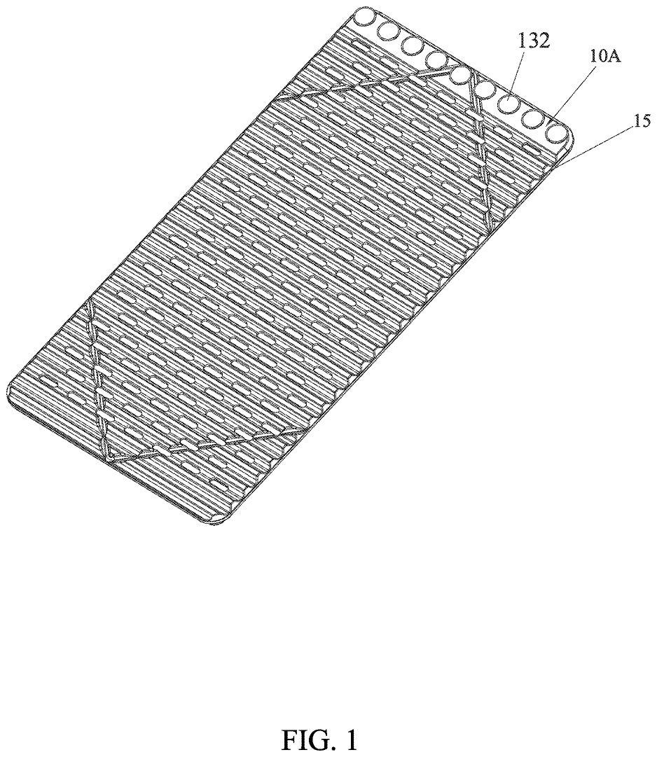

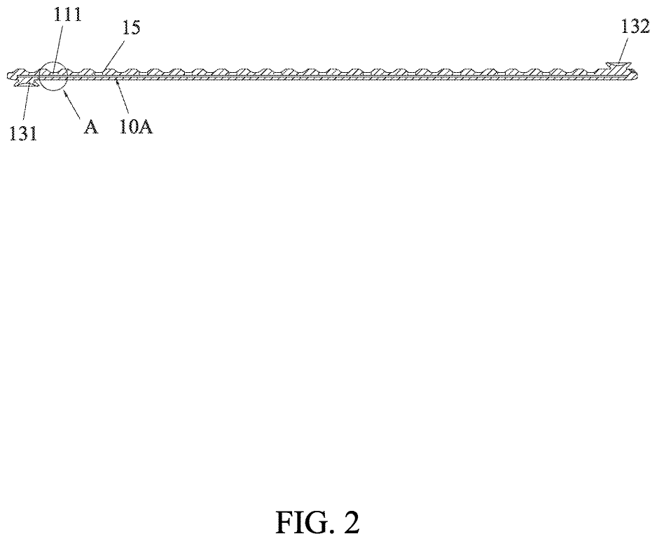

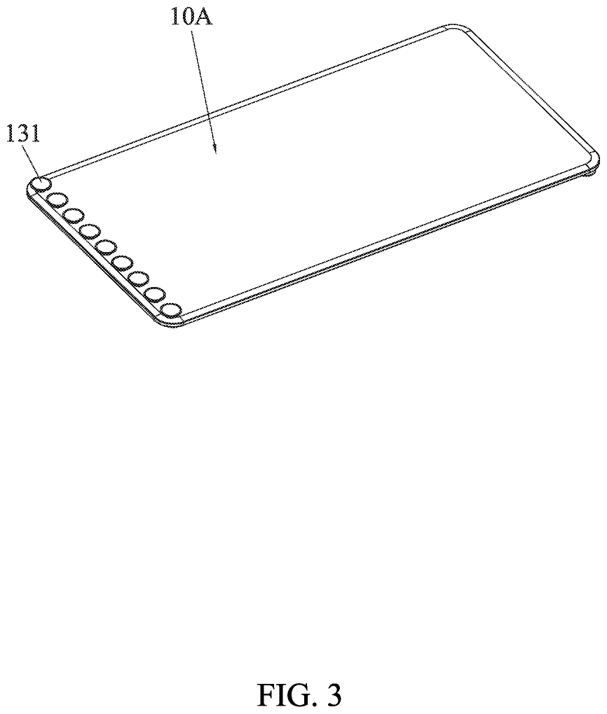

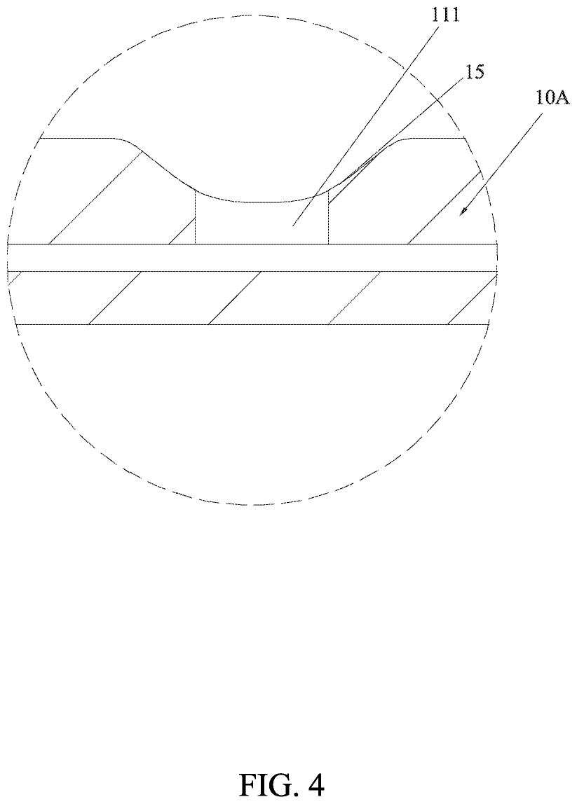

Referring to FIGS. 1-11, which illustrates the specific structure of the embodiments of the present disclosure.

In the description of the present disclosure, it should be noted that for directional words, terms such as “up”, “down”, “front”, “back”, “left”, “right”, etc., indicating directional and positional relationships based on the attached drawings or normal wearing and use, are only for the convenience of describing the present disclosure and simplifying the description, and do not indicate or imply that the device or component referred to must have a specific orientation, be constructed and operated in a specific orientation, and cannot be understood as limiting the specific protection scope of the present disclosure.

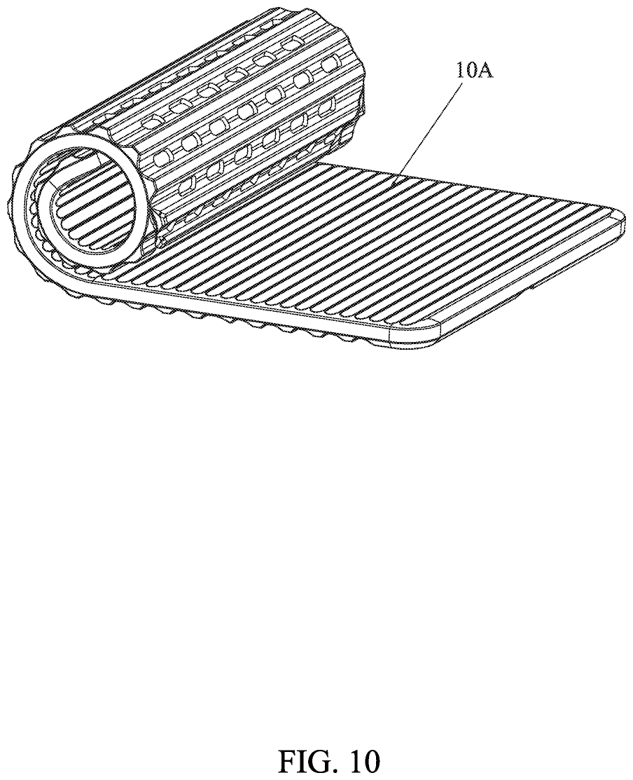

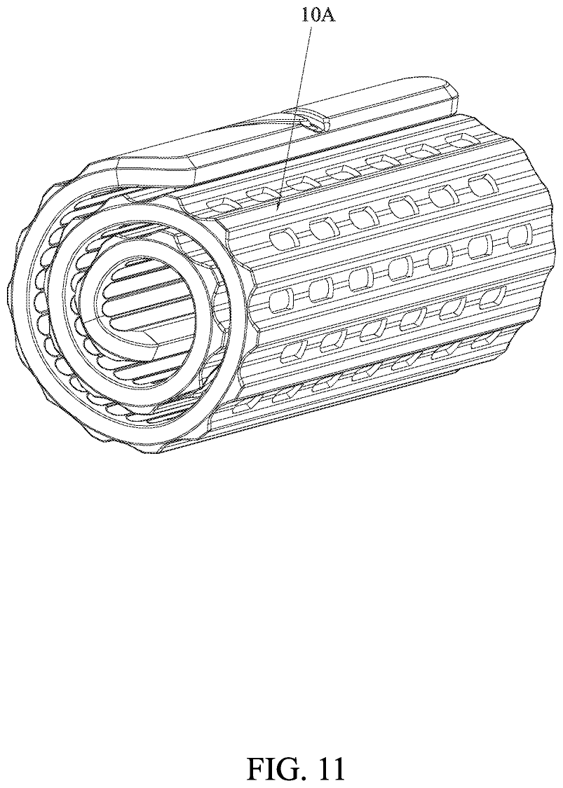

A flexible deformation holder including a foldable plate body 10A;
on one side of the foldable plate body 10A, there are a plurality of first foldable portions 15 arranged in parallel spacing; the first foldable portions 15 are used for bending deformation of the foldable plate body 10A and can be maintained after bending deformation to bend the foldable plate body 10A into the holder;
the foldable plate body 10A has a non-working state and a bent use state; in the non-working state, the foldable plate body 10A is in a flat plate shape; in the bent use state, the foldable plate body 10A can be bent along the first foldable portions 15 to bent the foldable plate body 10A to form the holder; when in use, the own material characteristics of the foldable plate body 10A are used for bending, so that the foldable plate body 10A can be bent into the holder; when not in use, it can be stored in a sheet shape or folded up for easy carrying and storage; referring to FIG. 10, the foldable plate body 10A is stored in a semi roll shape; referring to FIG. 11, the foldable plate body 10A is stored in a fully rolled shape;
the foldable plate body 10A has a front and back surface that are relatively arranged; the front and back surfaces are respectively provided with a first suction member and a second suction member for adsorbing adsorbable objects, and the first suction member and the second suction member are arranged staggered;
the first suction member and the second suction member are arranged staggered, with the first suction member being a first suction cup 131 and the second suction member being a second suction cup 132.

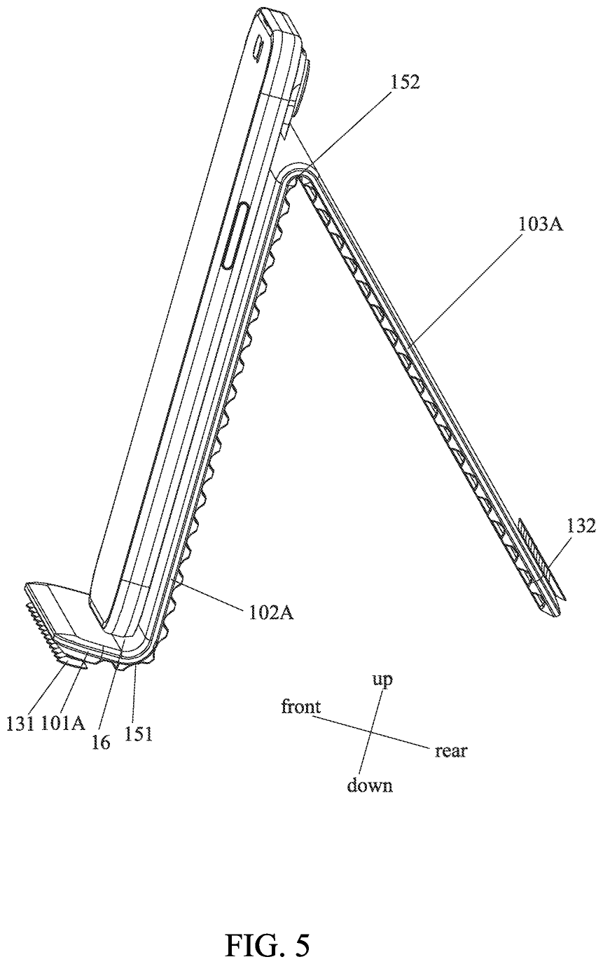

Referring to FIG. 5, it is a first usage state of the foldable plate body 10A; there are at least two first foldable portions 15, which are defined as a first bending portion 151 and a second bending portion 152, respectively; the foldable plate body 10A is divided into a first support body 101A, a second support body 102A, and a third support body 103A; the first bending portion 151 is provided at a junction of the first support body 101A and the second support body 102A, and the second bending portion 152 is provided at a junction of the second support body 102A and the third support body 103A;
when in the bent use state, the first support body 101A can be bent upward relative to a front end of the second the support body 102A through the first bending portion 151, so that an electronic device placement area 16 is enclosed between the first support body 101A and the second support body 102A (at this time, the second suction cup 132 on the first support body 101A is adsorbed on a desktop), and the third support body 103A can be bent downward relative to a rear end of the second support body 102A through the second bending portion 152; the second suction cup 132 on the first support body 101A is designed to avoid loosening during bending use;
where the first support body 101A is used to carry an electronic device, the second support body 102A is used to support a back of the electronic device, and the third support body 103A forms a support for the second support body 102A to ensure stability during use.

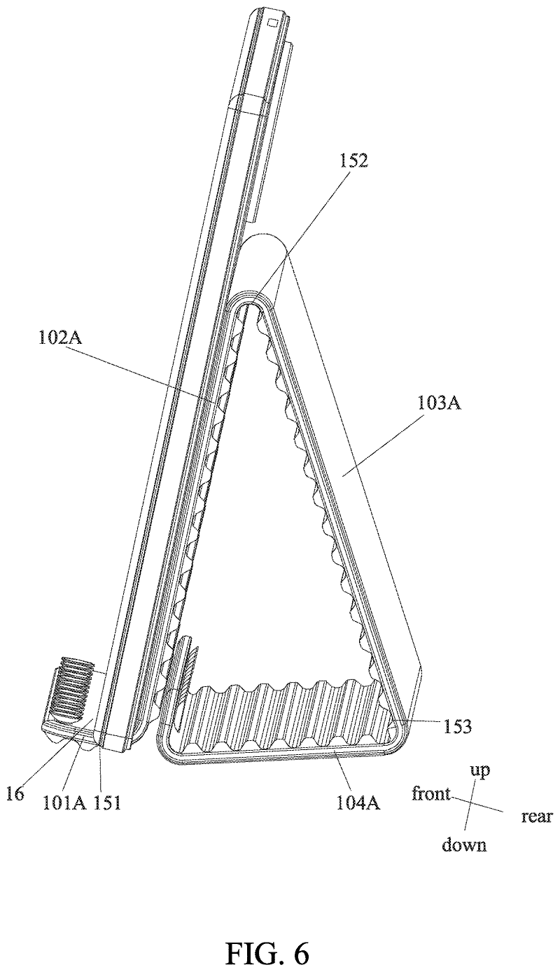

Referring to FIG. 6, it is a second usage state of the foldable plate body 10A; there are at least three first foldable portions 15, which are defined as a first bending portion 151, a second bending portion 152, a third bending portion 153, and a fourth bending portion 154. The foldable plate body 10A is divided into a first support body 101A, a second support body 102A, a third support body 103A, a fourth support body 104A, and a fifth support body 105A; the first bending portion 151 is provided at a junction of the first support body 101A and the second support body 102A, the second bending portion 152 is provided at a junction of the second support body 102A and the third support body 103A, and the third bending portion 153 is provided at a junction of the third support body 103A and the fourth support body 104A;
when in the bent use state, the first support body 101A can be bent upward relative to a front end of the second support body 102A through the first bending portion 151, so that the electronic device placement area 16 is enclosed between the first support body 101A and the second support body 102A (at this time, the second suction cup 132 on the first support body 101A is adsorbed on the desktop), and the electronic device placement area 16 is arranged at an obtuse angle to form a primary support; the third support body 103A can be bent downward relative to a rear end of the second support body 102A through the second bending portion 152, and the fourth support body 104A can be bent downward relative to a lower end of the third support body 103A through the third bending portion 153; so that a triangular support structure is formed between the second support body 102A, the third support body 103A, and the fourth support body 104A, thereby forming a secondary support; the fifth support body 105A can be bent upward relative to a front end of the fourth support body 104A through the fourth bending portion 154, so that a front end of the fifth support body 105A contacts a rear end surface of the second support body 102A, further forming support for the second support body 102A; the second support body 102A and the third support body 103A are both inclined; when a mobile phone is placed in the electronic device placement area 16, a non-screen side of the electronic device is attached to the second support body 102A, and a charging interface end of the electronic device contacts the first support body 101A; or
the fifth support body 105A can be bent downwards relative to the front end of the fourth support body 104A through the fourth bending portion 154, so that the second suction cup on the fifth support body 105A can be attached to the desktop to enhance its stability.

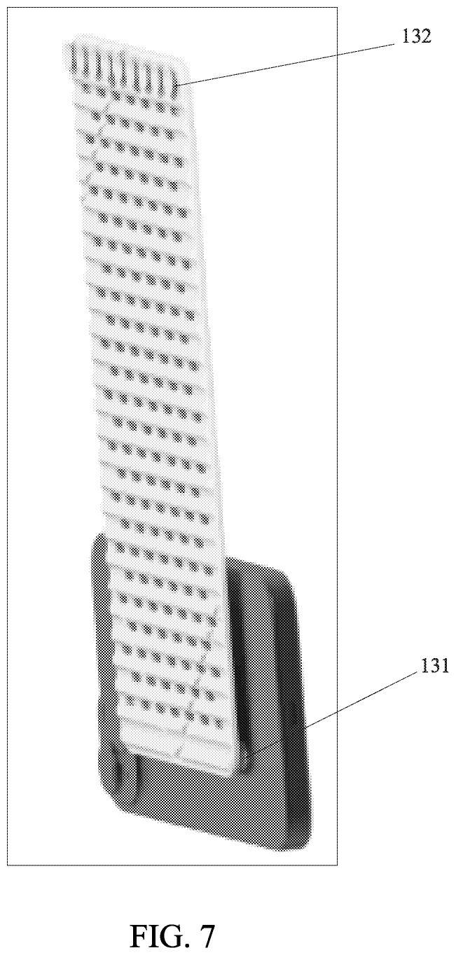

Referring to FIG. 7, it is a third usage state of the foldable plate body 10A (a wall holder); when the wall holder is used, it only needs to set the first suction cup 131 and the second suction cup 132 on the front and back of the foldable plate body 10A, respectively; the back is attached to the electronic device through the first suction cup 131 to form a connection, and the front is attached to an adsorbable object (wall or mirror) through the second suction cup 132, so that the foldable plate body 10A can be used as the wall holder without any bending.

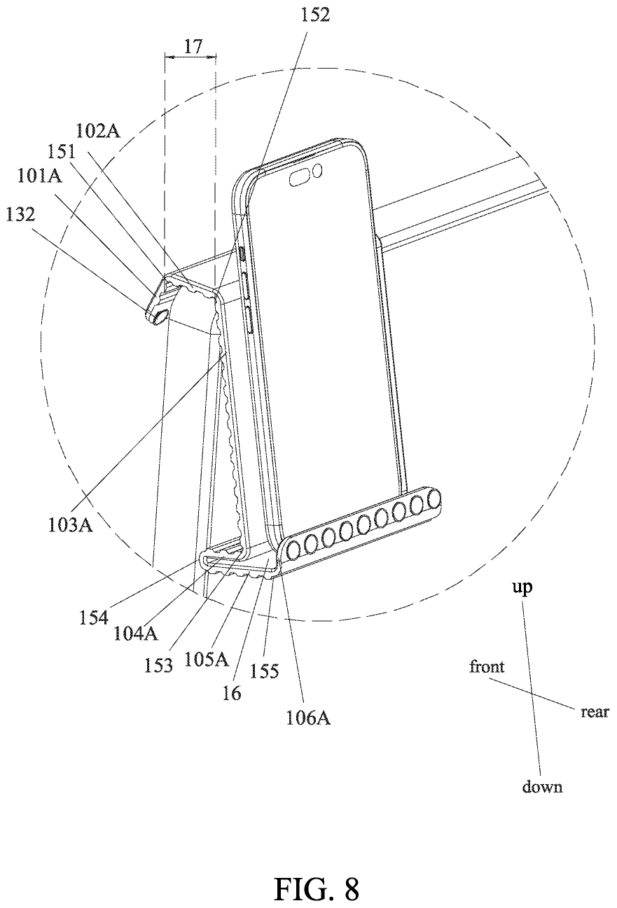

Referring to FIG. 8, it is a fourth usage state (wall holder) of the foldable plate body 10A; there are at least five first foldable portions 15, which are defined as a first bending portion 151, a second bending portion 152, a third bending portion 153, a fourth bending portion 154, and a fifth bending portion 155; the foldable plate body 10A is divided into a first support body 101A, a second support body 102A, a third support body 103A, a fourth support body 104A, a fifth support body 105A, and a sixth support body 106A; the first bending portion 151 is provided at a junction of the first support body 101A and the second support body 102A, the second bending portion 152 is provided at a junction of the second support body 102A and the third support body 103A, and the third bending portion 153 is provided at a junction of the third support body 103A and the fourth support body 104A, the fourth bending portion 154 is provided at a junction of the fourth support body 104A and the fifth support body 105A, and the fifth bending portion 155 is provided at a junction of the fifth support body 105A and the sixth support body 106A;
when in a bent use state, the first support body 101A can be bent downwards relative to a front end of the second support body 102A through the first bending portion 151;
the third support body 103A can be bent downwards relative to a rear end of the second support body 102A through the second bending portion 152, so that a hanging position 17 for hanging on a display screen or an object is formed between the first support body 101A, the second support body 102A, and the third support body 103A; and the display screen or object is adsorbed by the second suction cup 132 at the first support body 101A to prevent it from loosening and falling off;
the fourth support body 104A can be bent forward relative to a lower end of the third bending portion 153 through the third bending portion 153, the fifth support body 105A can be bent downward relative to a front end of the fourth bending portion 154 through the fourth bending portion 154, and the sixth support body 106A can be bent upward relative to a rear end of the fifth support body 105A through the fifth bending portion 155, so that the electronic device placement area 16 is enclosed between the third support body 103A, the fifth support body 105A, and the sixth support body 106A. When the mobile phone is placed in the electronic device placement area 16, the bent sixth support body 106A can form a limit on the phone to prevent it from slipping out;
the foldable plate body 10A is further provided with a first inclined crease 18 and a second inclined crease 19, and the first inclined crease 18 and the second inclined crease 19 extend diagonally relative to the first foldable portions 15, and two ends of the first inclined crease 18 and the second inclined crease 19 extend to adjacent sides of the foldable plate body 10A, respectively.

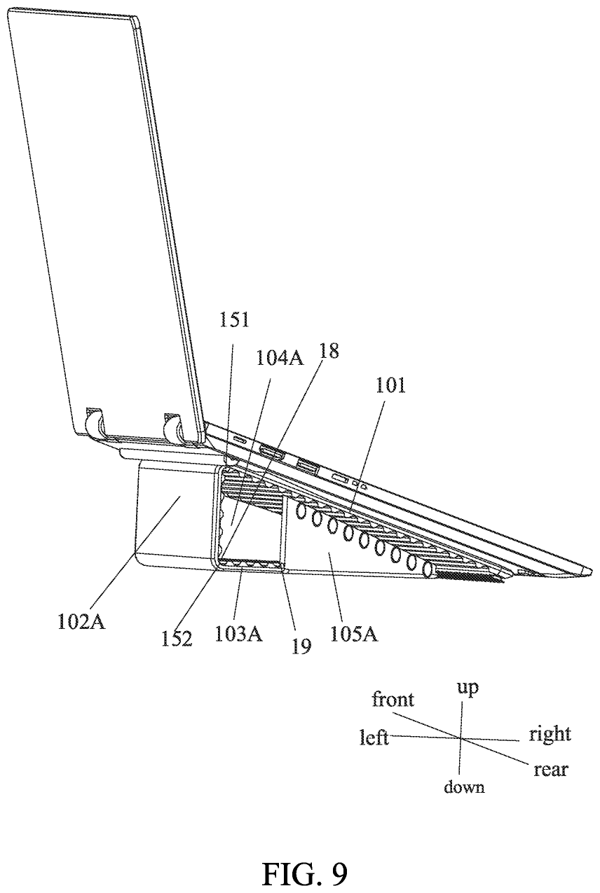

Referring to FIG. 9, it is a fifth usage state of the foldable plate body 10A; there are at least two first foldable portions 15, which are defined as a first bending portion 151 and a second bending portion 152, respectively; the foldable plate body 10A is divided into a first support body 101A, a second support body 102A, a third support body103A, a fourth support body 104A, and a fifth support body 105A;
when in the bent use state, the second support body 102A can be bent downwards relative to the front end of the second support body 102A through the first bending portion 151, the third support body 103A can be bent backwards relative to the lower end of the second support body 102A through the second bending portion 152, the fourth support body 104A can be bent upwards relative to a left end of the third support body 103A through the first inclined crease 18, and the fifth support body 105A can be bent upwards relative to a right end of the third support body 103A through the second inclined crease 19, so that upper ends of the fourth support body 104A and the fifth support body 105A are respectively in contact with the first segment; a holder structure is formed between the first support structure 101A, the second support body 102A, the third support body 103A, the fourth support body 104A, and the fifth support body, where the first support body 101A is used for the placement of the electronic device.

In some embodiments of the present disclosure, the foldable plate body 10A is made of aluminum, copper, or iron material.

The design focus of the present disclosure is mainly on the structure design of the foldable plate body 10A, which can be transformed into various placement states during bending, and can meet the user's different angle usage requirements;
secondly, the bending, unfolding, and closing operation of the foldable plate body 10A is simple; when in use, the foldable plate body 10A is bent using its own material characteristics to form the holder; when not in use, it can be folded into a sheet or folded for storage, taking up less space and rendering it convenient to carry and store;
and through the design of the plurality of first foldable portions 15, the foldable plate body 10A can be bent and deformed, and can be maintained after bending deformation; then, the cooperation between the plurality of first foldable portions 15 and the foldable plate body 10A can be easily transformed into various placement states; at the same time, the first foldable portions 15 can provide bending guidance to facilitate bending along the first foldable portions 15.

The above description is only the preferred embodiment of the present disclosure and does not limit the technical scope of the present disclosure. Therefore, any minor modifications, equivalent changes, and modifications made to the above embodiments based on the technical essence of the present disclosure still fall within the scope of the technical solution of the present disclosure.

What is claimed is:

1. A flexible deformation holder, comprising: a foldable plate body,
wherein a plurality of first foldable portions arranged in parallel spacing are provided on one side of the foldable plate body,
the first foldable portions are configured for bending deformation of the foldable plate body and are configured to be maintained after bending deformation so as to bend the foldable plate body into the holder.

2. The flexible deformation holder according to claim 1, wherein there are at least two first foldable portions, which are defined as a first bending portion and a second bending portion, respectively; correspondingly, the foldable plate body is divided into a first support body, a second support body, and a third support body;
the first bending portion is provided at a junction of the first support body and the second support body, and the second bending portion is provided at a junction of the second support body and the third support body;
when in a bent use state, the second support body is configured to bent upwards relative to a front end of the first support body through the first bending portion, thereby forming an electronic device placement area between the first and second support bodies; the third support body is configured to bent downwards relative to a rear end of the second support body through the second bending portion.

3. The flexible deformation holder according to claim 1, wherein there are at least three first foldable portions, which are respectively defined as a bending portion, a second bending portion, and a third bending portion; correspondingly, the foldable plate body is divided into a first support body, a second support body, a third support body, and a fourth support body;
the first bending portion is provided at a junction of the first support body and the second support body, the second bending portion is provided at a junction of the second support body and the third support body, and the third bending portion is provided at a junction between the third support body and the fourth support body,
when in a bent use state, the first support body is configured to bent upward relative to a front end of the second support body through the first bending portion, thereby forming an electronic device placement area between the first and second support bodies; the third support body is configured to be bent downward relative to a rear end of the second support body through the second bending portion; the fourth support body is configured to be bent forward relative to a lower end of the third support body through the third bending portion, thereby forming a triangular support structure between the second, third, and fourth support bodies.

4. The flexible deformation holder according to claim 1, wherein the foldable plate body has a front and back surface that are relatively arranged, and the front and back surfaces are respectively provided with a first suction member and a second suction member configured to adsorb adsorbable objects, and the first suction member and the second suction member are arranged staggered.

5. The flexible deformation holder according to claim 1, wherein there are at least five first foldable portions, which are defined as a first bending portion, a second bending portion, a third bending portion, a fourth bending portion, and a fifth bending portion, respectively;
correspondingly, the foldable plate body is divided into a first support body, a second support body, a third support body, a fourth support body, a fifth support body, and a sixth support body;
the first bending portion is provided at a junction of the first support body and the second support body, the second bending portion is provided at a junction of the second support body and the third support body, the third bending portion is provided at a junction of the third support body and the fourth support body, the fourth bending portion is provided at a junction of the fourth support body and the fifth support body, and the fifth bending portion is provided at a junction of the fifth support body and the sixth support body;
when in a bent use state, the first support body is configured to be bent downwards relative to a front end of the second support body through the first bending portion; the third support body is configured to be bent downwards relative to a rear end of the second support body through the second bending portion, so that a hanging position configured to hang on a display screen or an object is formed between the first support body, the second support body, and the third support body;
the fourth support body is configured to be bent forward relative to a lower end of the third bending portion through the third bending portion;
the fifth support body is configured to be bent downwards relative to a front end of the fourth bending portion through the fourth bending portion; the sixth support body is configured to be bent upwards relative to a rear end of the fifth support body through the fifth bending portion, so that an electronic device placement area is formed between the third support body, the fifth support body, and the sixth support body.

6. The flexible deformation holder according to claim 1, wherein the foldable plate body is further provided with a first inclined crease and a second inclined crease, and the first inclined crease and the second inclined crease extend obliquely relative to the first foldable portions, and two ends of the first inclined crease and the second inclined crease respectively extend to adjacent two sides of the foldable plate body.

7. The flexible deformation holder according to claim 6, wherein there are at least two first foldable portions, which are respectively defined as a first bending portion and a second bending portion, and the foldable plate body is divided into a first support body, a second support body, a third support body, a fourth support body, and a fifth support body;
when in a bent use state, the second support body is configured to be bent downwards relative to a front end of the second support body through the first bending portion, the third support body is configured to be bent backwards relative to a lower end of the second support body through the second bending portion, the fourth support body is configured to be bent upwards relative to a left end of the third support body through the first inclined crease, and the fifth support body is configured to be bent upwards relative to a right end of the third support body through the second inclined crease, so that upper ends of the fourth and fifth support bodies respectively abut against the first support body, and a holder structure is formed between the first support body, the second support body, the third support body, the fourth support body, and the fifth support body,
wherein the first support body is configured to place an electronic device.

8. The flexible deformation holder according to claim 1, wherein the foldable plate body is made of aluminum, copper, or iron material.
